(19) United States
(12) Patent Application Publication
(10) Pub. No.: US 2026/0346759 A1
(43) Pub. Date: Nov. 5, 2026

(54) TAILGATE SEAT

(71) Applicant: MACNEIL IP LLC, Bolingbrook, IL (US)

(72) Inventors: David F. MacNeil, Fort Lauderdale, FL (US); Stephen Kane, Cedar Lake, IN (US)

(73) Assignee: MACNEIL IP LLC, Bolingbrook, IL (US)

(21) Appl. No.: 19/181,608

(22) Filed: Apr. 17, 2025

(51) Int. Cl. B60N 2/005; B60N 3/10; B62D 33/027

(52) U.S. Cl. CPC B60N 2/005; B60N 3/101; B62D 33/027

(57) ABSTRACT

Spaced apart through holes are made in an elastomeric foam tailgate seat body. Respective grommets are inserted through the through-holes, such that a top flange of the grommet is disposed adjacent an upper surface of the seat body, and such that a bottom flange of the grommet is disposed adjacent a lower surface of the seat body. At each of a plurality of tailgate bolt holes, an affixation member is affixed. A first detenting surface on the inner surface of a grommet sidewall is snapped to a second detenting surface on an upstanding sidewall of the affixation member. In this way, the tailgate seat is releasably fastened to the upper/inner surface of the tailgate.

### BACKGROUND OF THE INVENTION

The field of the invention is automotive aftermarket products, and more particularly relates to padded seats for affixation to tailgates and like components of vehicles.

Pickup trucks and many SUVs have a rear body panel that may be swung down around a transverse hinge to a horizontal position, to permit or enhance access to a rear cargo area. These panels typically are called “tailgates.” As lowered to a horizontal position, these tailgates provide a surface on which people can sit. While mats and liners have been provided to line the upper or interior-facing surface of tailgates against damage from the contents of the cargo area, to date no provision has been made to better adapt a tailgate upper surface for human seating by use of a releasably attachable accessory.

### SUMMARY OF THE INVENTION

According to one aspect of the invention, a tailgate seat comprises a seat body having an upper surface, a lower surface and a plurality of through-holes each of which extend between the upper surface and the lower surface. For each through-hole there is provided a fastening system. The fastening systems fasten the seat body to the tailgate. Each fastening system includes a grommet with a top flange, a bottom flange downwardly spaced from the top flange, and a sidewall formed around a grommet axis. The sidewall downwardly extends from the top flange to, and past, the bottom flange, to a lower end. The bottom and top flanges radially outwardly extend from an external surface of the sidewall. A first detenting surface is formed on an internal surface of the sidewall. The fastening system further includes an affixation member or snap which is affixed to an upper surface of the tailgate. The affixation member is disposed on the axis and has a base and a sidewall upwardly extending from the base. A second detenting surface is formed on an external surface of the sidewall of the affixation member. This second detenting surface is adapted to engage the first detenting surface. The top flange of the grommet is disposed on the upper surface of the seat body and the bottom flange is disposed on the lower surface of the seat body. In use, the first detenting surface of the grommet snaps to the second detenting surface of the affixation member, thereby affixing the tailgate seat to the tailgate.

In one embodiment, the first detenting surface may be radially inwardly concave and the second detenting surface may be radially outwardly convex. In this or other embodiments, the sidewalls of the grommet and/or of the affixation member may be endless in a plane orthogonal to the axis. In this or other embodiments, the first and/or the second detenting surfaces may be endless, in a plane orthogonal to the axis, such as ring-shaped.

In one embodiment, the base of the affixation member has a central hole disposed on the axis. A threaded bolt or screw is inserted through this central hole and is used to fasten the affixation member to the tailgate. In one embodiment, the top flange of the grommet may radially inwardly extend across the sidewall of the grommet, closing the interior space otherwise defined by the inner surface of the sidewall and creating a cap.

In one embodiment, the grommet further has a plurality of gussets, each of which has a lower edge that radially inwardly and downwardly extends from an outer edge of the bottom flange. The gussets are radially spaced from each other. These gussets are used to temporarily force open the respective through-hole in the seat body, so as to permit the passage therethrough of the bottom flange.

According to another aspect of the invention, a tailgate seat is provided for affixation to an upper surface of a tailgate of a vehicle. The tailgate has an upper surface with a plurality of spaced-apart bolt holes at predetermined locations. A seat body of the tailgate seat is formed of an elastomeric foam and has an upper surface and a lower surface. A plurality of through-holes are spaced apart from each other and each extend between the upper surface and the lower surface. A respective affixation member or snap is affixed to the tailgate upper surface at each of the bolt holes. The affixation member has an upstanding sidewall with an exterior surface. A respective grommet is inserted through each through-hole. A first detenting surface is formed on an interior surface of a sidewall of the grommet. A second detenting surface is formed on the exterior surface of the sidewall of the affixation member. The first detenting surface snaps to the second detenting surface in order to releasably affix the tailgate seat to the tailgate.

In one embodiment, a rear edge of the tailgate seat may have a raised lip.

In one embodiment, the tailgate seat may further include a beverage container caddy, clamped to the upper surface of the seat body by caddy bolts inserted through washers, through the seat body and through bolt boss holes formed by the caddy. Knobs are threaded to shafts of the caddy bolts to clamp the cup caddy to seat body. The elasticity of the seat body creates clamping force that holds the cup caddy in place.

According to another aspect of the invention, a method of affixing a tailgate seat to a tailgate is provided. The method includes removing, from each of a plurality of predetermined, spaced-apart bolt hole locations in an upper surface of the tailgate, an original bolt. Then, an affixation member is affixed at each bolt hole. A seat body is provided with a plurality of through-holed each extending between a seat body upper surface and a seat body lower surface. A respective grommet is inserted into each of these through-holes, such that a top flange of the grommet is disposed adjacent the upper surface of the seat body and such that a bottom flange of the grommet is disposed adjacent the lower surface of the seat body. Then, and for each grommet, a first detenting surface, located on an interior surface of the sidewall of the grommet, is snapped to a second detenting surface, located on an exterior surface of an upstanding sidewall of the affixation member. This results in releasably fastening the tailgate seat to the tailgate.

In one embodiment of the method, the step of affixing the affixation member to the respective bolt hole comprises screwing a bolt or screw through a hole in the affixation member and into the bolt hole.

In a further aspect of the invention, a beverage container caddy may be affixed either to an upholstered pad, such as the tailgate seat described herein, or to an upstanding feature of a piece of furniture, such as an upholstered arm of an easy chair. For this purpose the caddy may be provided in kit form. In one configuration, washers as above described are used, and are placed below the bottom surface of the pad. For each of first and second caddy bolts, the caddy bolt is upwardly inserted through the washer, through the pad, and into and through a respective bolt boss hole. A knob is then threaded onto each caddy bolt shaft and tightened so as to clamp the caddy to the upholstered pad.

In a second configuration, first and second brackets are substituted for the washers. Each bracket has a first plate with first and second transverse ends and a transversely oriented slot formed between its lower surface and its upper surface. A second plate of the bracket downwardly extends from the first transverse end. In use, the shaft of a third caddy bolt is upwardly inserted through the slot in the first plate of the first bracket and then into a first bolt boss hole. A first knob is then threaded onto the shaft of the third caddy bolt. This assembly is repeated with a fourth caddy bolt, the second bracket, the second bolt boss hole and a second knob.

The caddy is then placed on an upper surface of the upstanding furniture feature. The transverse position of each of the second plates of the first and second brackets is adjusted so that they respectively press against first and second sidewalls of the furniture feature. The user then tightens the knobs to clamp the caddy firmly to the furniture feature.

In the illustrated embodiment, each bracket is transversely reversible. The bracket may be attached to the caddy body such that the first transverse end of the first plate of the bracket is closer to the caddy longitudinal axis than is its second transverse end, or alternatively such that the second transverse end of the first plate of the bracket is closer to the caddy axis than is the first transverse end. The brackets may be attached to the caddy such that the second plates thereof are both “out”, both “in”, or one “out” and one “in”. This permits the caddy to be attachable to upstanding furniture features (such as chair arms) of various transverse widths, and further permits the caddy to be transversely inwardly or outwardly displaced from a longitudinal axis of the furniture feature. For example, the caddy does not have to sit right on top of a chair arm but can be positioned somewhat inside or outside of it.

The caddy may be provided with brackets only and no washers, if only clamping to a chair arm or the like is desired.

The present invention thus provides a comfortable and cushionable seating surface which may be easily snapped onto, and later removed, from the tailgate upper/inner surface. A beverage container caddy is also provided for use with the tailgate seat and for separate use.

### BRIEF DESCRIPTION OF THE DRAWINGS

Further aspects of the invention and their advantages can be discerned in the following detailed description as read in conjunction with the drawings of exemplary embodiments, in which like characters denote like parts and in which:

FIG. 1A is a top left rear perspective view of a tailgate seat installed on a tailgate of a typical pickup truck;

FIG. 1B is a top right rear perspective view of a tailgate seat installed on a tailgate of a typical pickup truck, the depicted tailgate seat also including a beverage container caddy;

FIG. 2A is a top rear right perspective view of a tailgate seat body;

FIG. 2B is a bottom rear perspective view of the tailgate seat body shown in FIG. 2A;

FIGS. 3A-3C are different perspective views of a grommet for use with the invention;

FIGS. 4A and 4B are bottom and top perspective views, respectively, of an affixation member or snap for use with the invention and an associated attachment bolt;

FIG. 5 is a longitudinal sectional view taken in the plane of a grommet axis, showing the grommet and snap being used to install the tailgate seat on an OEM tailgate;

FIGS. 6A and 6B are top and bottom perspective views of a beverage container caddy for use with the invention, together with mounting bolts, washers and knobs;

FIGS. 7A and 7B are longitudinal sectional views showing stages of attachment of the beverage container caddy to the tailgate seat body;

FIG. 8 is top left perspective view of a typical pickup truck tailgate in a lowered position, prior to installation of the tailgate seat of the invention;

FIG. 9 is a perspective view showing one of the grommets being snapped to a corresponding snap which has been installed on the vehicle tailgate;

FIG. 10 is a schematic block diagram showing steps in the installation of the tailgate seat of the invention;

FIG. 11 is a rear perspective view of a beverage container caddy similar to the one shown in FIGS. 6A and 6B, but with alternative mounting brackets for affixation of the caddy to an upstanding furniture feature;

FIG. 12 is a transverse sectional view taken substantially along Line 12-12 of FIG. 11;

FIGS. 13A and 13B are opposed perspective views of a first bracket for use with the invention, a second bracket being identical;

FIG. 14A is a bottom rear perspective view of the caddy with second vertical plates of the first and second brackets being both placed in transversely outer positions;

FIG. 14B is a bottom rear perspective view of the caddy with the second plates of the first and second brackets being both placed in transversely inner positions;

FIG. 14C is a bottom rear perspective view of the caddy with the second plate of the first bracket being placed in a transversely outer position, but with the second plate of the second bracket being placed in a transversely inner position;

FIG. 15 is a front, part-sectional view of a caddy with second plates of the brackets at widest outer transverse position being used to clamp the caddy to an upholstered chair arm; and

FIG. 16 is a perspective detail of a representative caddy bolt for use with the first and second caddy brackets.

### DETAILED DESCRIPTION

For purposes of this specification and of the claims, “longitudinal” is aligned to the direction of vehicle travel when the vehicle is not turning. “Longitudinal” is the same as fore and aft and is a direction in a horizontal plane. “Transverse” is a horizontal direction at 90 degrees to “longitudinal” and is also in a horizontal plane. “Transverse” is the same as side-to-side. “Vertical” means a direction that is at 90 degrees to “transverse” and to “longitudinal”. Usually, it is the same as up and down. In environments where a piece of furniture is involved rather than a vehicle, “longitudinal” means from front to back or back to front, such as for a seat.

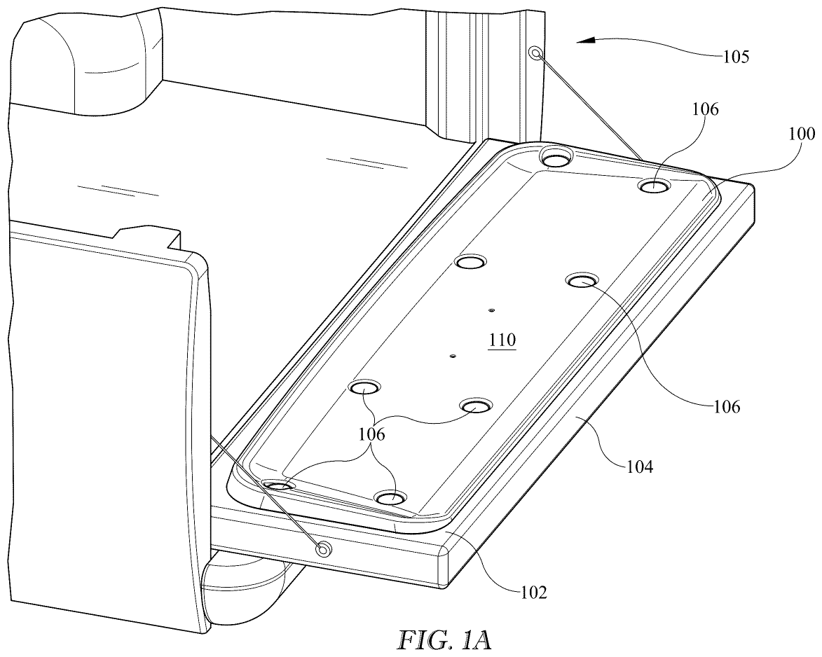

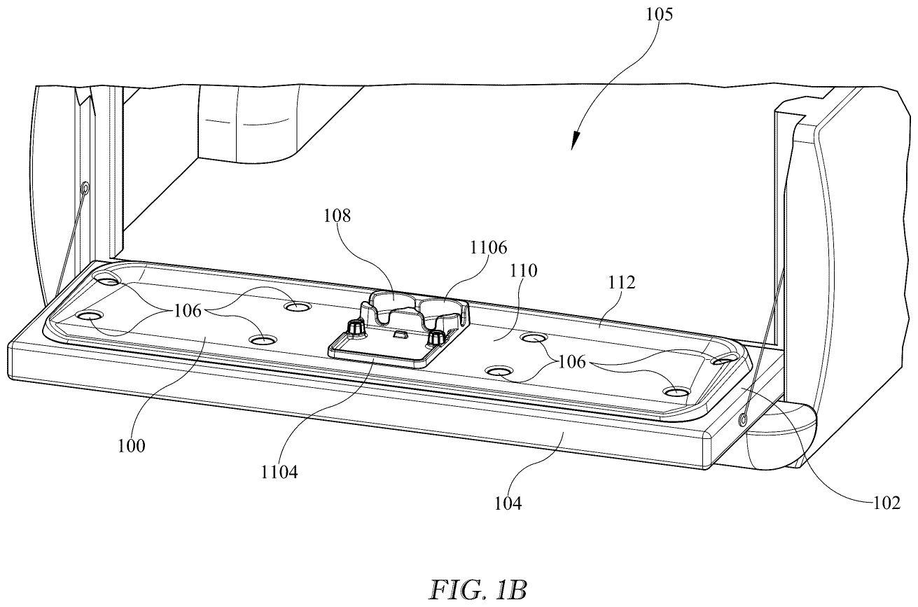

Referring to FIG. 1A, a tailgate seat 100 is shown installed on an upper surface 102 of a tailgate 104 of a typical conventional pickup truck 105, in this case a 2024 Ford F150. The tailgate seat 100 is affixed to tailgate upper surface 102 with the aid of a plurality of grommets 106, which, as will be explained, snap on to affixation members or snaps (not shown in FIG. 1A). The tailgate 104 is a rear panel of the vehicle 105, which is hinged on a transverse axis from an upright position (not shown) to the horizontal position shown here. The tailgate seat 100 has application to any vehicle having such a rear panel or tailgate 104, and may be used with other pickup trucks or with those SUVs which have both lower and upper gates.

For different makes and models of vehicles, the number and location of the grommets 106 may vary, since, as will be explained, the tailgate seat 100 is affixed to tailgate upper surface 102 using preexisting original equipment manufacturer (OEM) holes (not shown in FIG. 1A) in the upper surface 102. In the illustrated embodiment, there are eight such grommets 106, in a 2×4 array.

In the embodiment shown in FIG. 1B, a beverage container caddy 108 has been added to the transverse middle of the upper surface 110 of the tailgate seat body 112. In the illustrated embodiment, the caddy 108 is mounted to the seat body upper surface 110 at a position that does not overlap with any of the grommets 106. This is useful because the tailgate seat body 112 is constructed of a foamed elastomer and the caddy 108, which may be formed of a relatively harder plastic, is clamped to the tailgate seat body using the elasticity of the foamed elastomer to hold the cup caddy 108 in place. The position and extent of the beverage container caddy 108 still afford seating for at least two human occupants, at least one on either side.

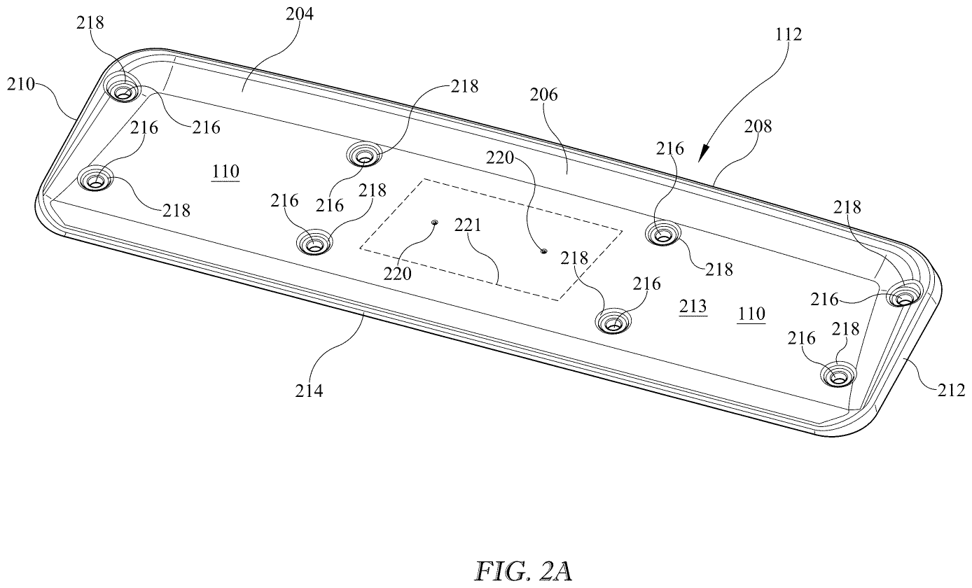

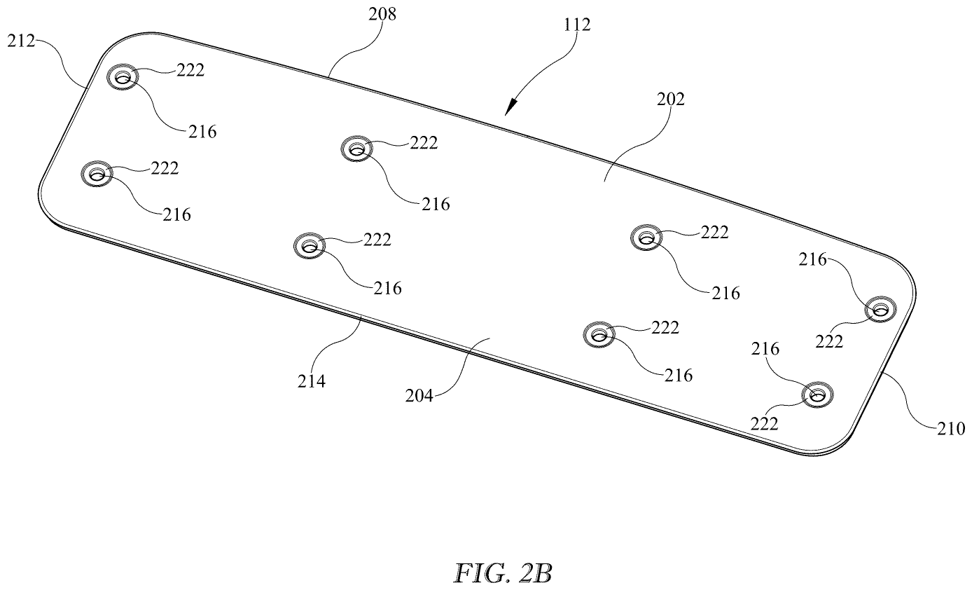

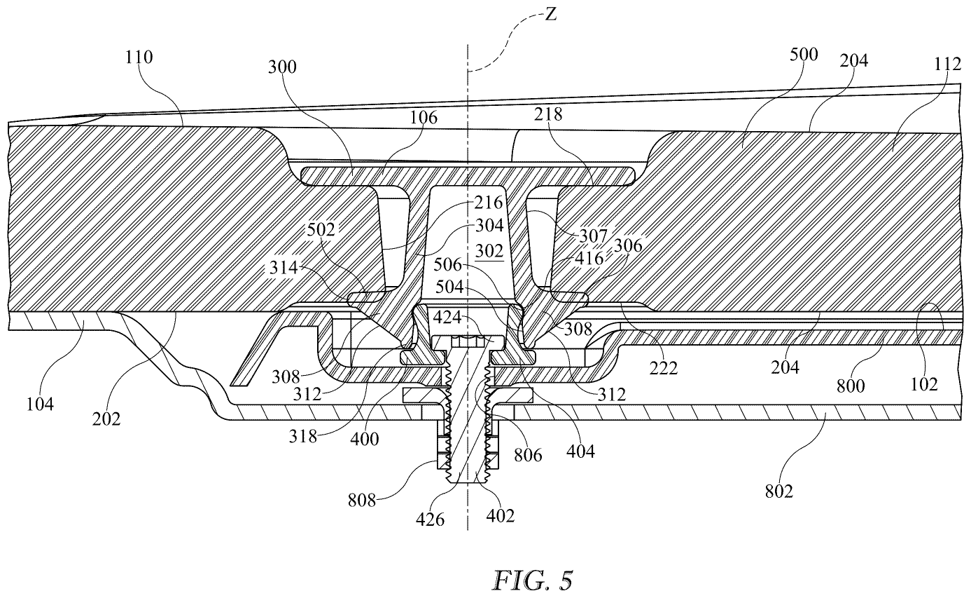

As seen in FIGS. 2A and 2B, the seat body 112 has an upper surface 110 and a lower surface 202. The seat body 112 may be integrally molded from a foamed elastomer. More particularly, the body 112 may be cast using a molten foaming polyurethane. After hardening, the body 112 will have a fluid-impervious flexible skin 204 and a foamed interior 500 (FIG. 5). After molding, the body 112 may have a density of about 9.75 pounds per cubic foot, and a durometer of about 18 on the A scale.

The upper surface 110 (FIG. 2A) may not be flat and may instead have a longitudinally upwardly concavely curved portion or raised lip 206 near its rear edge 208. A left edge 210 and a right edge 212 may also be raised relative to a center portion 213. The thickness of the body 112 in a vertical direction may be relatively greater at raised lip 206 and smaller near a front edge 214.

A plurality of through-holes 216 are made through the seat body 112 from the upper surface 110 to the lower surface 202. Each of the through-holes 216 is transversely and longitudinally spaced apart from all other through-holes 216. Each of the through-holes 216 will be fitted with a grommet, as will be hereinafter explained. The number and location of the through-holes 216 may vary from one make and model of vehicle to the next, and in one embodiment depend on the number and location of certain OEM holes made in the tailgate upper surface 102 (FIG. 8). An annular depression or countersink 218 is made around each through-hole 216 on upper surface 110. Also visible on upper surface 110 in one embodiment are two transversely spaced-apart dimples 220, inboard from all of the through-holes 216. Dimples 220 mark the location of fastening bolts for attachment of the beverage container caddy 108, as will be hereinafter described. Although not evident on the actual physical part, an outline 221, rendered in broken line, shows where the outer periphery (described below) of the optional beverage container caddy 108 would be placed. That outer periphery is horizontally spaced from the closest through-holes 216, and therefore is substantially spaced from the grommets that will occupy those through-holes.

As seen in FIG. 2B, the lower surface 202 of seat body 112 may generally conform to a horizontal plane, except for a plurality of annular depressions or countersinks 222 made in lower surface 202 around each of the through-holes 216. In other embodiments, where the OEM tailgate upper surface 102 has a topography that is not flat, the surface 202 could be made to be a mirror image of surface 102.

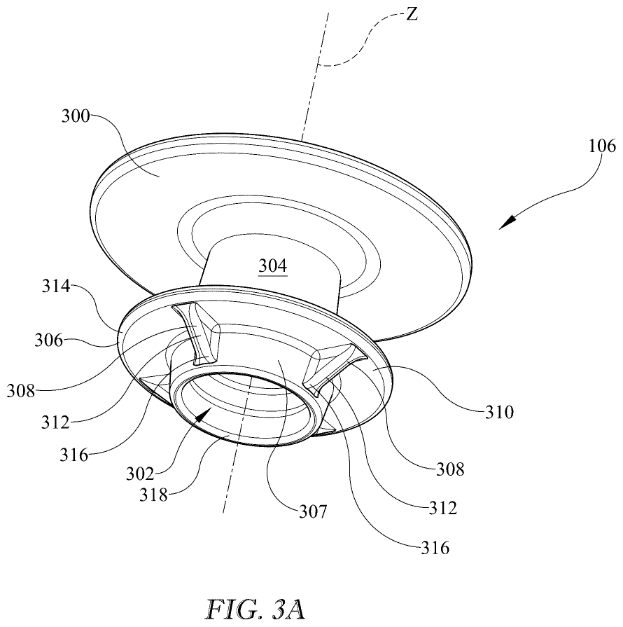

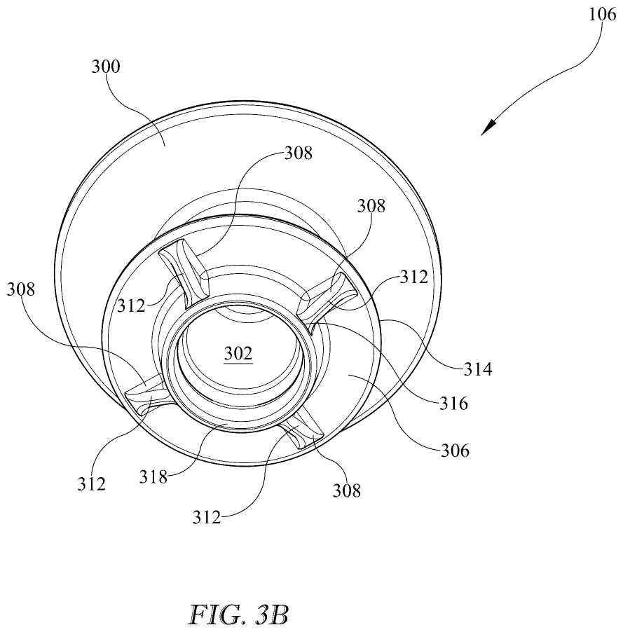

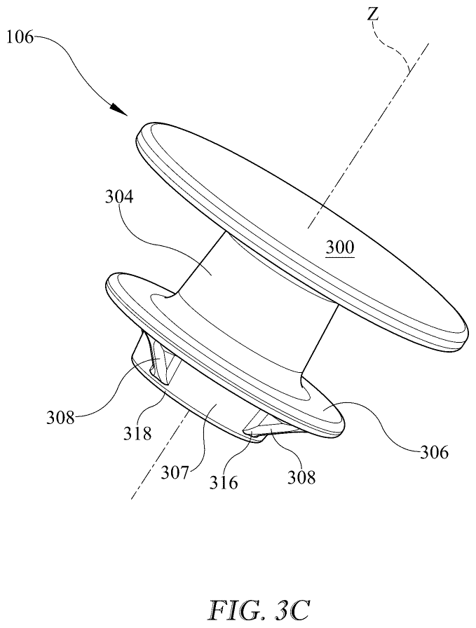

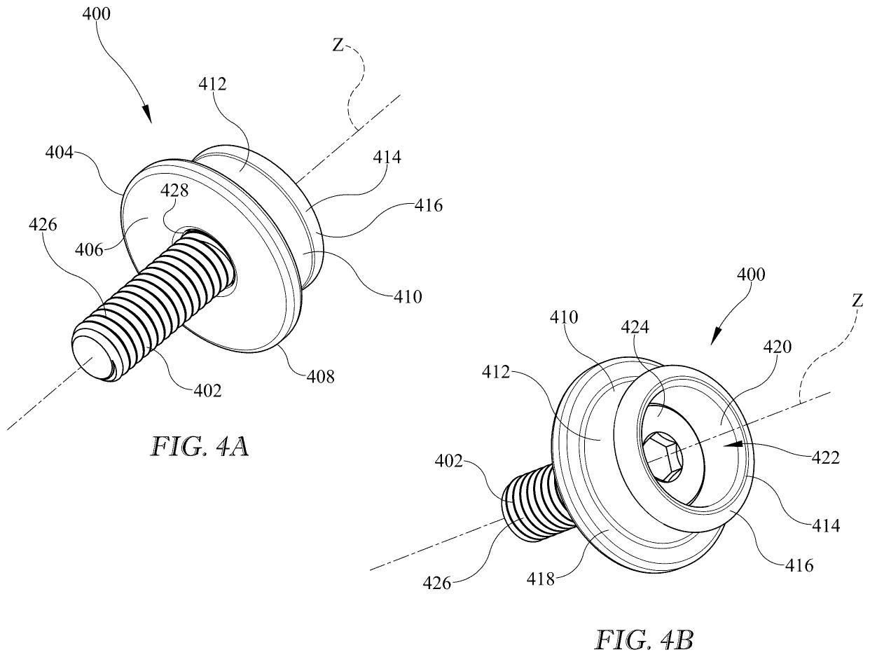

In the illustrated embodiment, each through-hole 216 is associated with a respective fastening system that includes a grommet 106 (FIGS. 3A-3C) and a corresponding affixation member or snap 400 (FIGS. 4A and 4B). The grommet 106 may be substantially radially symmetrical and formed around an axis Z, which as assembled will be substantially vertical. A top flange 300 is continuous and closed in the illustrated embodiment, so as to be the ceiling of an inner chamber 302 defined by a circumferential sidewall 304. The top flange radially outwardly extends from sidewall 304. Spaced below the top flange 300 is a bottom flange 306, which also radially outwardly extends from sidewall 304. Top flange 300 can be a disk or cap, while bottom flange 306 may take the form of an annulus.

A plurality of angularly spaced apart gussets 308 each radially extend from an outer surface 307 of sidewall 304 and extend upwardly to a lower surface 310 of the bottom flange 306. Each of the gussets 308 has a lower edge 312 that extends radially inwardly and downwardly from an outer edge 314 of the bottom flange 306 to the outer surface 307 of the sidewall 304. The lower edges 312 may be straight, as shown. The lower end 316 of each edge 312 may be at or near a lower end 318 of the sidewall 304.

As seen in FIG. 5, each grommet 106 is forced through a respective through-hole 216 until the bottom flange 306 is all the way through the through-hole 216. This force-fit is aided by the wedge-shaped gussets 308, which temporarily widen the sides of the through-hole 216. After the bottom flange 306 is all of the way through the through-hole 216, the foamed interior 500 will snap back toward the outer sidewall surface 307 between top flange 300 and bottom flange 306.

As seen in FIGS. 4A and 4B, the other members of the fastening system are an affixation member or snap 400, and a bolt 402 used to affix the affixation member 400 to the tailgate 104. The affixation member 400 has a base 404 whose lower surface 406 will, in use, rest on the upper surface 102 of tailgate 104. The base 404 may be annular, as shown, but its outer periphery or edge 408 could take any other convenient shape, such as one designed to fit into a depression in the tailgate upper surface 102. Upstanding from the base 404 is a sidewall 410, which in the illustrated embodiment is continuous or endless in a horizontal plane. The sidewall 410 may be circular, as shown. The shape of sidewall 410 in any event should be so selected that it will best engage with the inner surface of grommet sidewall 304. Alternatively, the sidewall 410 could be vertically divided into cylindrical segments to aid in flexing when receiving a respective grommet 106.

In the illustrated embodiment, an outer surface 412 of the sidewall 410 terminates, at its upper end 414, in a convex detenting surface, enlargement or ring 416. The ring 416 is upwardly displaced from an upper surface of 418 of the base 404.

An inner surface 420 of the sidewall 410 defines a cavity 422 designed to receive a head 424 of the bolt 402. A shaft 426 of the bolt 402 is inserted through a central hole 428 in the base 404 that communicates with the cavity 422.

FIG. 5 is a cross-sectional view showing how the grommet 106 and the snap 400 are used to fasten the seat body 112 to the tailgate 104. With temporary reference to FIG. 8, the tailgate 104 of this particular vehicle is comprised of a plastic panel 800 and an underlying structural member 802 formed of steel sheet. To attach the panel 800 to structural member 802, the original equipment manufacturer used eight OEM bolts 804, inserted into respective bolt holes 806 and threaded into respective clips 808 (one such seen in FIG. 5). As a first step, these OEM bolts 804 are removed. At each location of a bolt hole 806, a bolt 402 is inserted through a snap 400, into bolt hole 806, and then threaded to clip 808. At the end of this step, there will be a plurality of snaps 400 at each of the selected locations, with upstanding sidewalls 410 and detenting rings 416.

Prior to this time, a respective grommet 106 had been inserted through each through-hole 216 in the seat body. The triangularly-shaped gussets 308 act to force outward the sidewall of the through-hole 216 as the grommet 106 is pushed downward and partially through the through-hole 216. Once this is done, the lower surface 218 of the top flange 300 rests on the upper surface of countersink 218, while the upper surface 502 of bottom flange 306 will press against bottom surface countersink 222 in an interference fit.

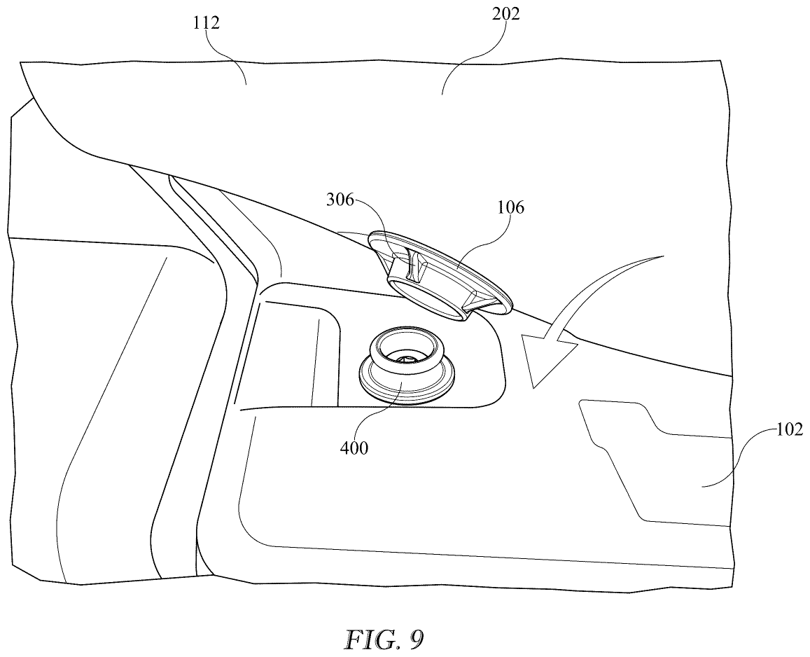

As seen in FIG. 9, the mat body 202 is aligned such that each grommet 106 is aligned with a respective snap 400. The grommets 106 are then snapped to the snaps 400 to affix the seat body 112 to the tailgate 104.

Returning to FIG. 5, the grommet sidewall 304 has an interior lead surface 504 that upwardly and somewhat inwardly extends from lower sidewall end 318. The lead surface 504 ends at a concave detenting surface 506, which in the illustrated embodiment is curved and endless in a horizontal plane. The detenting surface 506 can be a mirror image of base detenting surface or ring 416. In an alternative embodiment, the detenting surface 506 could be convex, while the detenting surface 416 could be concave.

Sidewall 304 is somewhat elastically flexible. When lead surface 504 cams along ring 416 as the grommet 105 is forced onto snap 400, the sidewall 304 will flex outward. When ring 416 is received into groove 506, the grommet sidewall 304 will resiliently snap back to its original position. Thereafter, the grommet 106 will not decouple from snap 400 without the application of a certain amount of prying force.

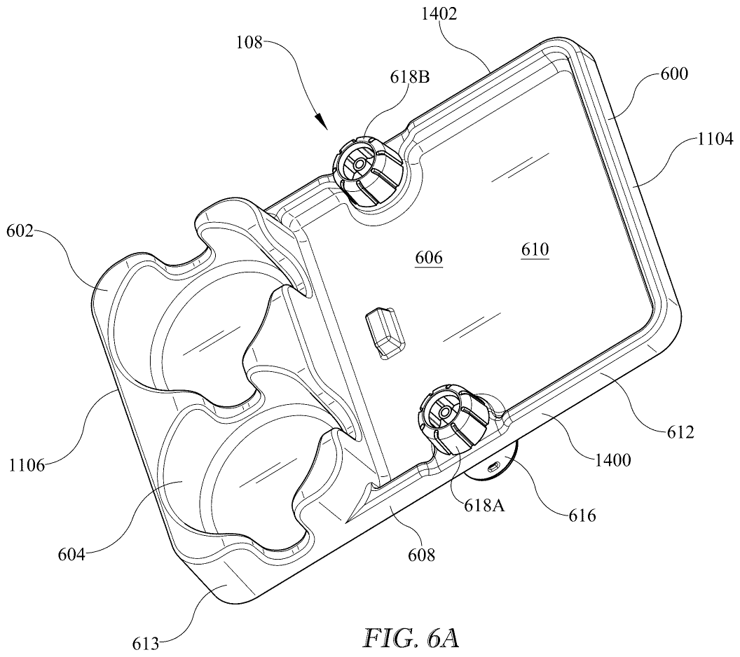

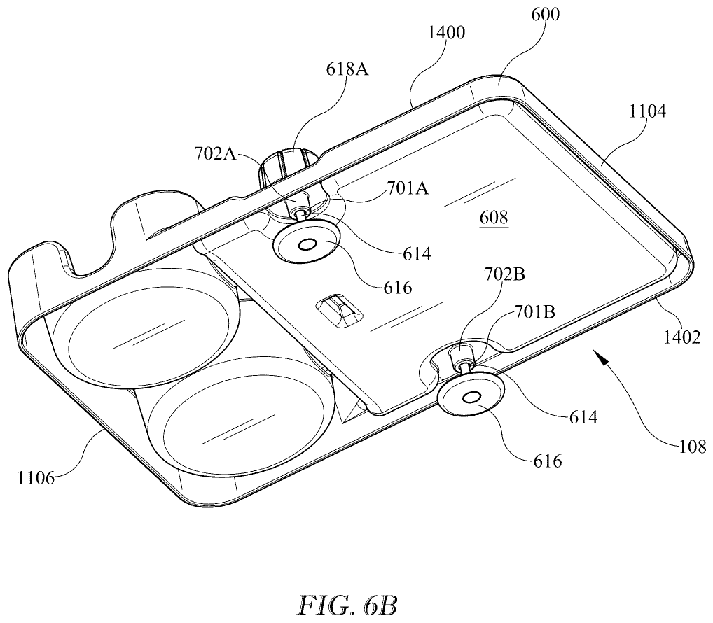

Optionally, the tailgate seat could include a beverage container caddy 108, one form of which is shown in FIGS. 6A and 6B. A body 600 of the caddy 108 may be injection-molded as a single piece from plastic. Caddy 108 may have a pair of cup, drink or beverage container receptacles 602, 604, each of which extends upwardly from a general upper surface 606 of a cup caddy base 608. In other embodiments only one such beverage container receptacle could be provided. The upper surface 606 may further define a more general deposit area 610 with a laterally surrounding wall 612. The general deposit area 610 may receive snacks or other articles. The laterally surrounding wall is part of an outer periphery 613 that, once installed on the upper surface 200 of the seat body 112, will match the outline 221. The caddy body 600 may be substantially rectangular in shape and may have a front side 1106, a rear side 1104 longitudinally displaced from the front side 1106, a first longitudinal or right side 1402, and a second longitudinal or left side 1400 transversely spaced from side 1402. Relative to caddy 108, “front”, “rear”, “right” and “left” are arbitrarily assigned here, as in use caddy 108 could be reversed from the orientation shown. For example, while the “front” side 1104 of caddy 108 has been placed to be closer to the rear of tailgate 104 than has “rear” side 1106 (see FIG. 1B), the caddy 108 could easily be installed the other way, such that “rear” side 1106 would be closer to the rear of tailgate 104 than would be “front” side 1104.

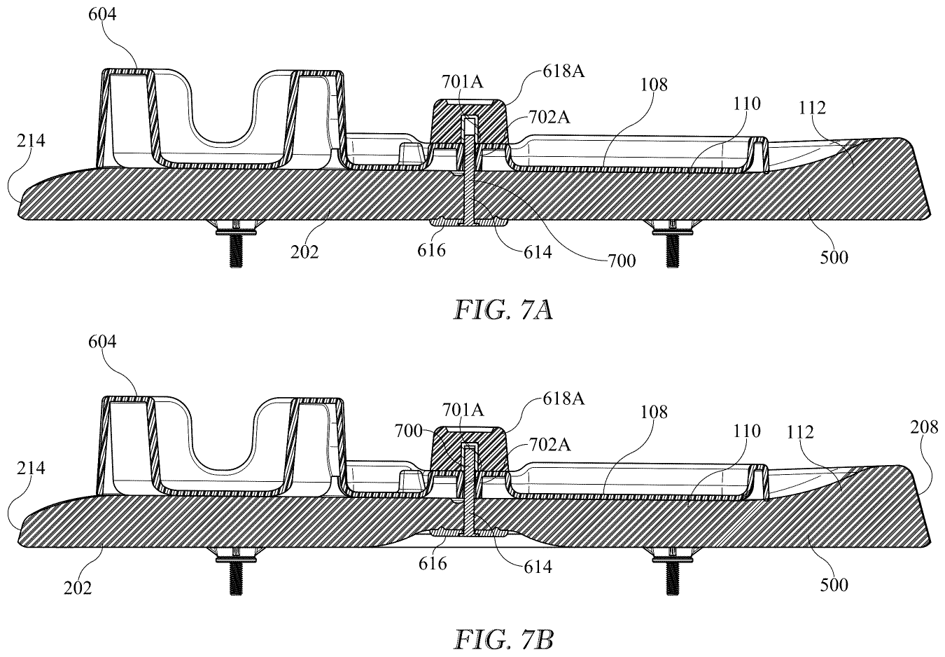

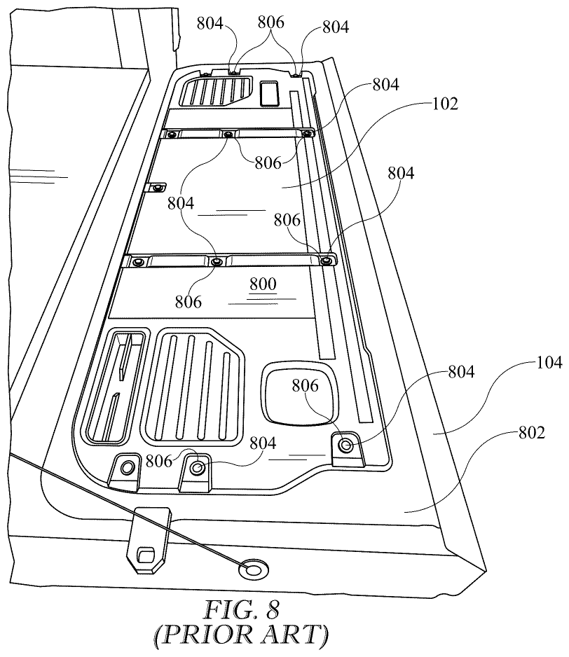

As seen in FIGS. 6A and 6B, the beverage container caddy 108 is affixed to the seat body 112 with the aid of bolts 614, washers 616 and knobs 618A and 618B. At a location on lower body surface 202 that corresponds to an upper surface dimple location 222, and as best seen in FIGS. 7A and 7B, a shaft 700 of bolt 614 is upwardly inserted through a washer 616, through the foamed interior 500 and into a hole 701A defined by a respective boss 702A of the caddy 108. Then, a knob 618A is screwed onto the threaded shaft 700. Because the body 112 is made of a foamed elastomer, as the knob 618A is tightened down on shaft 700, the washer 616 will begin to make a depression in the body lower surface 202. Similarly, a shaft 700 of the other bolt 614 is inserted through the other washer 616, through the foamed interior 500 and into a hole 701B defined by a boss 702B of the caddy 108. Then a knob 618B is screwed onto the shaft 700 of the other bolt 614. The caddy 108 is thus affixed by compressive force to the seat body 112 against the tendency of elastomeric foamed interior 500 to return to its original molded form.

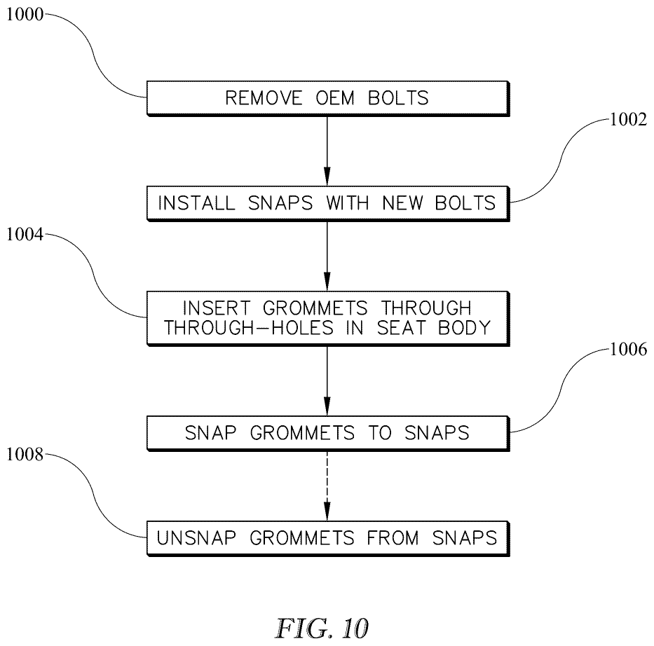

Reviewing the method of installing a tailgate seat 100 on a tailgate 104, and referring to FIG. 10, at step 1000 OEM bolts 804 are removed from each of a plurality of bolt holes 806 formed in the tailgate 104 (FIG. 8). The selected bolt holes 806 are widely longitudinally and transversely spaced from each other to best affix the seat body 112 to the tailgate 104. At step 1002, and at each selected bolt hole 806, a bolt 402 is used to affix the snap 400 to a position above the bolt hole 806. At step 1004, respective grommets 106 are inserted through the seat body through-holes 216, the number and location of which match the number and location of the installed snaps 400. Step 1004 may be performed prior to the other steps, and may be done by the consumer or at the factory. At step 1006, and as shown in FIG. 9, the seat body 112 is so aligned that the grommets 106 become coaxial with respective snaps 400. Then, the grommets 106 are snapped to the snaps 400, one at a time.

An advantage of the invention is that the grommets 106 and snaps 400 allow the easy removal of the tailgate seat 100 from tailgate 104 without tools—as is represented by step 1008. The tailgate seat then may be stored separately until the next “tailgate” outing.

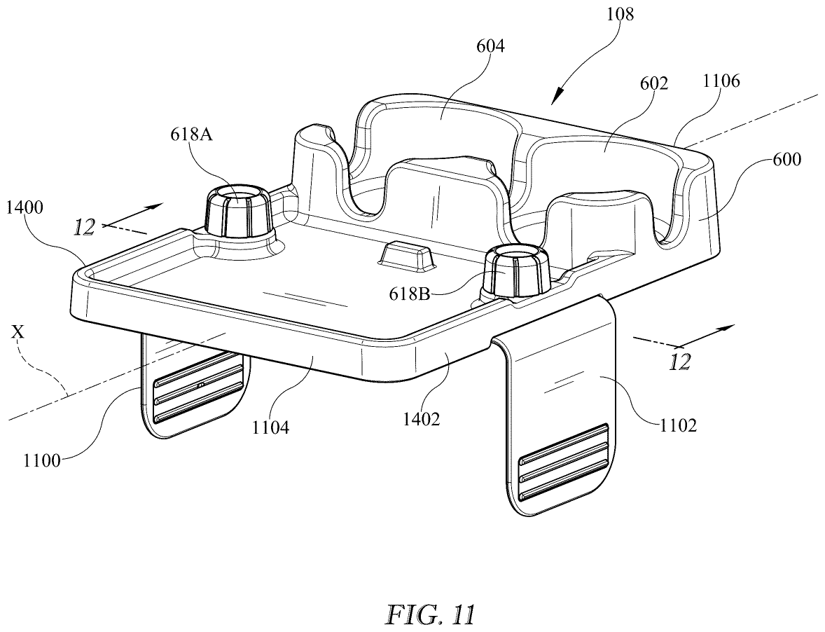

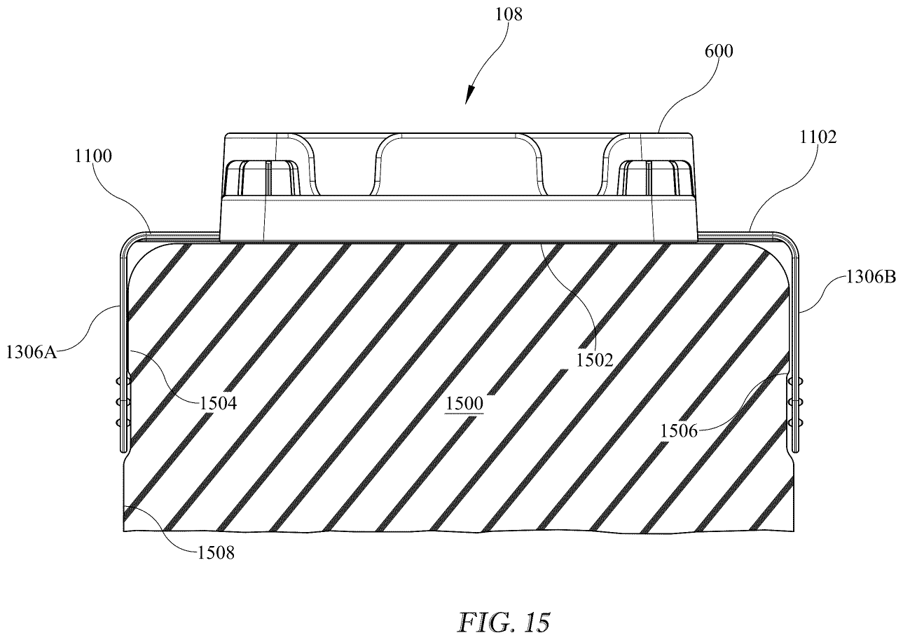

Referring now to FIG. 11, the caddy 108 provided for optional use with tailgate seat 100 may be used separately from it for attachment to another base, which may be upholstered. The caddy 108 may be provided as a kit with first and second brackets 1100, 1102 in addition to washers 616, and pairs of bolts for each. First and second brackets 1100, 1102 are used when it is desired to affix the caddy 108 to an upstanding furniture feature such as an arm of an easy chair (see FIG. 15). Washers 616 are used when it is desired to affix the caddy 108 to a substantially horizontal elastomeric pad, of which tailgate seat body 112 is only one example. Alternatively, caddy 108 may also be provided with brackets 1100, 1102 only and with no washers 616.

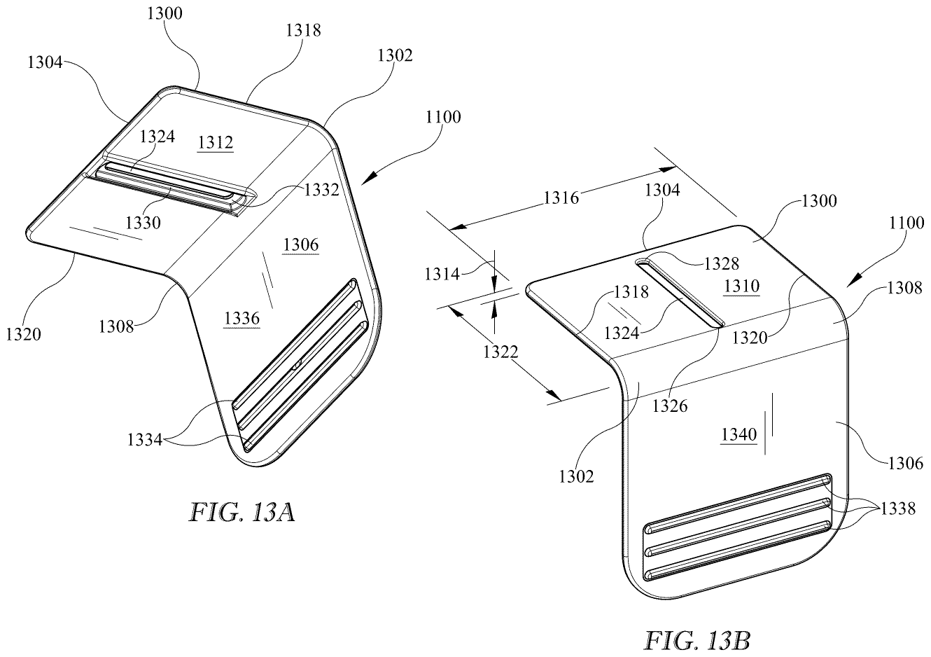

FIGS. 13A and 13B are perspective details of bracket 1100. In the illustrated embodiment bracket 1102 is identical to bracket 1100, although it doesn't have to be, and could be intentionally varied away from bracket 1100 in one of more dimensions, the variation of which might make the brackets 1100, 1102 more adaptable to affix caddy 108 to an upstanding furniture feature with an asymmetrical shape or surface. Brackets 1100, 1102 may be molded of a hard plastic such as ABS or may be fashioned of metal such as steel.

Bracket 1100 has a first plate 1300 (FIGS. 13A and 13B) which, in use, will be substantially horizontal. The first plate 1300 has a first transverse end 1302 and an opposed second transverse end 1304. A second plate 1306 downwardly extends from the first transverse end 102 at an angle, such as 90 degrees. There may be a curved transition 1308 between the first plate 1300 and the second plate 1306.

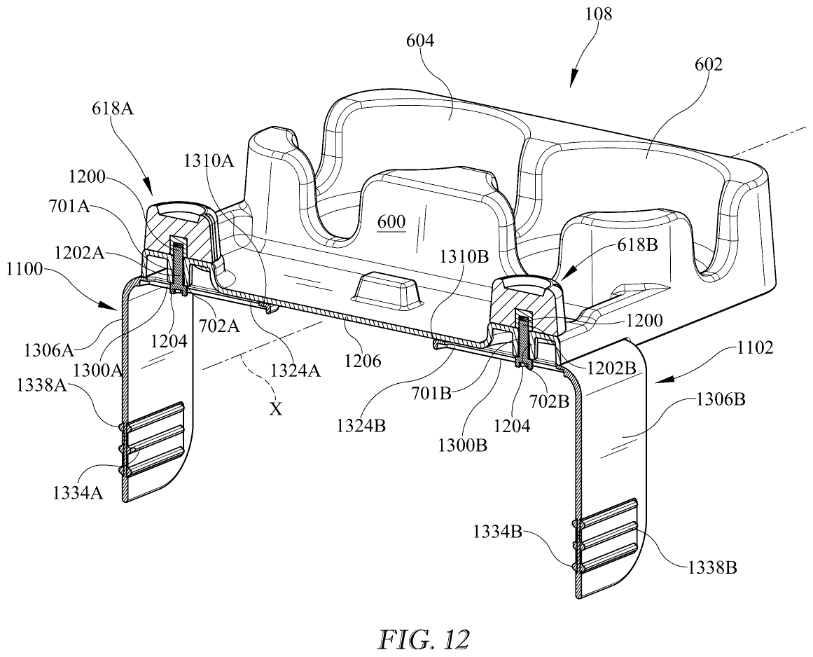

The first plate 1300 has an upper surface 1310 (FIG. 13B) which in use will be adjacent to a lower surface 1206 (FIG. 12) of the caddy body 600, and an opposed lower surface 1312 (FIG. 13A), which may be separated by a substantially uniform vertical thickness 1314 (FIG. 13B). The first plate 1300 has a predetermined depth 1316 in a longitudinal direction. The depth 1316 may be substantially uniform, as shown, or, in the instance that first plate longitudinal sides 1318 and 1320 are not parallel and/or straight, could be a maximum depth. The first plate further has a predetermined length 1322 in a transverse direction between transverse ends 1302 and 1304.

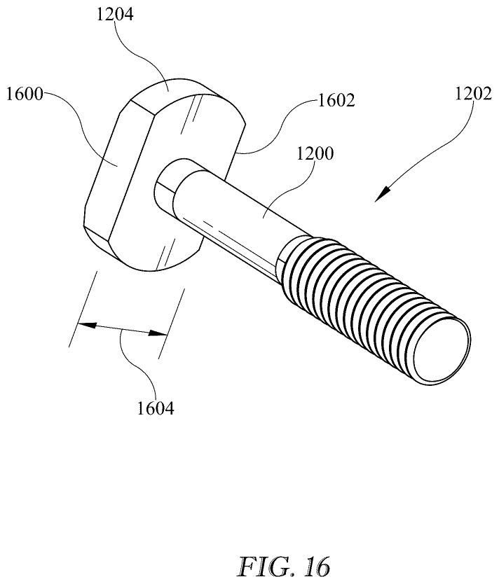

Plate 1300 has a transversely oriented, linear slot 1324 that extends from upper surface 1310 to lower surface 1312. First and second opposed ends 1326, 1328 of slot 1324 may be respectively positioned near first plate end 1302 and second plate end 1304. As seen in FIG. 13A, a relieved channel 1330 laterally surrounds slot 1324 and its ceiling 1332 is upwardly spaced from lower surface 1312. A width of slot 1324, in a longitudinal direction, should be wide enough to accommodate a shaft 1200 of caddy bolts 1202 and 1202A, B (FIGS. 12 and 16). A width in a longitudinal direction of channel 1330, and a height in a vertical direction of channel 1330, should be selected to accommodate and house a head 1204 of caddy bolt 1202 (FIG. 16).

A representative caddy bolt 1202 for use with brackets 1100, 1102 is shown in FIG. 16. In the illustrated embodiment, caddy bolts 1202A and 1202B (FIG. 12) are identical to each other and to the bolt 1202 shown in FIG. 16. The head 1204 has a first transversely oriented vertical flat face 1600 and an opposed parallel flat face 1602 separated from each other by a longitudinal distance 1604. The distance 1604 will be a little smaller than a longitudinal width of the relieved channel 1330. A thickness of head 1204 in the vertical direction will be a little smaller than the height of the relieved channel 1330. As installed into channel 1330, the faces 1600, 1602 will prevent bolt 1202 from rotating when the knob 618A or 618B is twisted. The shaft 1200 may be only partially threaded, as shown, to ease insertion through the channel 1324A or 1324B and the bolt boss hole 701A or 701B.

In the illustrated embodiment, the caddy bolts 1202A and 1202B are identical to each other, but in the instance that they are not, the dimensions of slot 1324A or slot 1324B, and the surrounding relieved channel 1330, would be altered to accommodate the altered bolt size.

Returning to FIG. 13A, a set of gripping elements 1334 may be formed on an inner surface 1336 of the second plate 1306. A similar set of gripping elements 1338 may be formed on an opposed outer surface 1340 of the second plate 1306 (FIG. 13B). The gripping elements may be formed of thermoplastic elastomer (TPE) and may be overmolded onto the opposed sides 1336, 1340 of second plate 1306. The second plate 1306A of first bracket 1100 has opposed gripping elements 1334A and 1338A, while the second plate 1306B of second bracket 1102 has opposed gripping elements 1334B and 1338B (FIG. 12).

As seen in the transverse sectional view of FIG. 12, when brackets 1100, 1102 are used, upper surfaces 1310A and 1310B of their respective first plates 1300A and 1300B will abut the lower surface 1206 of the caddy body 600. Bolt bosses 702A and 702B respectively define bolt boss holes 701A and 701B. A shaft 1200 of caddy bolt 1202A is inserted through slot 1324A and bolt boss hole 701A. A knob 618A, which may plastic overmolded onto a threaded brass or other metal core or sleeve, is threaded onto shaft 1200 of bolt 1202A. Similarly, the shaft 1200 of caddy bolt 1202B is inserted through slot 1324B and through bolt boss hole 701B. Knob 618B, which may be identical to knob 618A, is threaded onto the threaded shaft 1200 of bolt 1202B.

The caddy body 600 may be formed around a longitudinal axis X. In the illustrated embodiment, the beverage container receptacles 602, 604 are longitudinally displaced from the bolt bosses 701A and 701B and the knobs 618A and 618B. In use, the beverage container receptacles 602 and 604 may be positioned in front of the knobs 618A and 618B, or, the caddy body 600 may be reversed such that the beverage container receptacles 602 and 604 are positioned behind the knobs 618A and 618B.

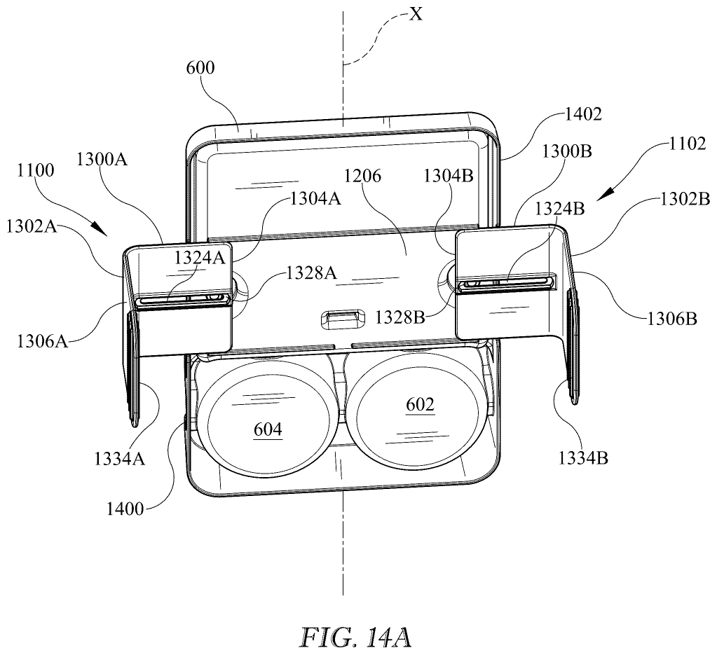

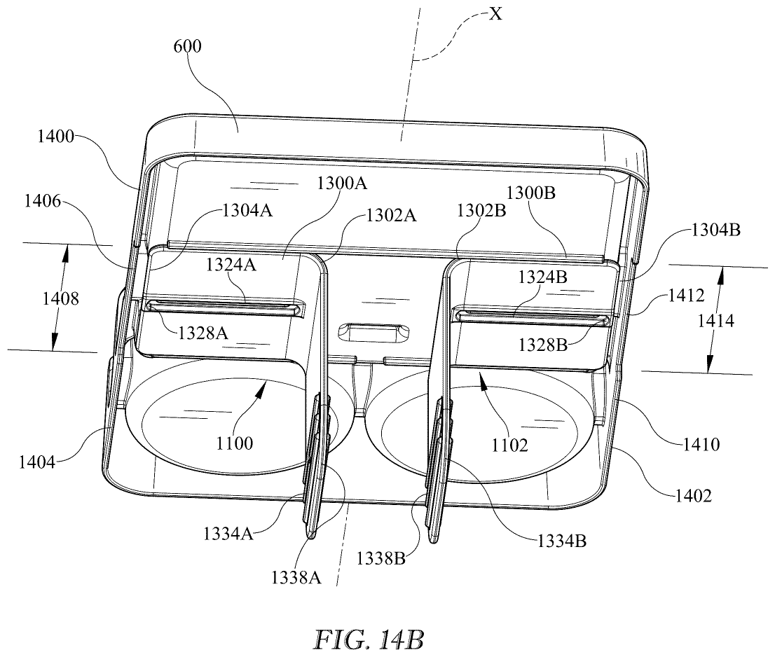

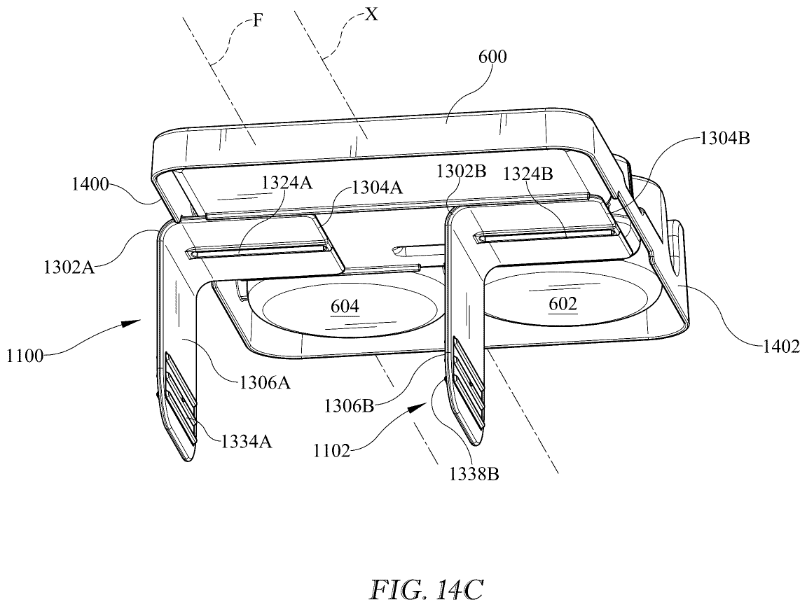

FIGS. 14A-14C illustrate three different configurations in which the brackets 1100, 1102 may be affixed to caddy body 600. The caddy bolts 1202A and 1202B have been omitted from FIGS. 14A-14C for clarity. In FIG. 14A, second plates 1306A and 1306B are disposed at their maximum transverse distance from each other and from longitudinal axis X. In this “both brackets out” configuration, slot end 1328A will be substantially aligned with the bolt boss hole 701A (FIG. 12) and slot end 1328B will be aligned with bolt boss hole 701B. The transverse positions of the slot ends 1328A and 1328B are different from the bolt boss hole axes only to the extent they need to accommodate the bolt heads 1204. The plate second ends 1328A and 1328B will be closer to longitudinal axis X than will be plate first ends 1302A and 1302B. The gripping elements 1334A and 1334B will be facing inwardly toward axis X and in that position will be adapted to grip respective sidewalls of an upstanding furniture feature (see FIG. 15). Second plate 1306A is disposed transversely farther away from axis X than is a first longitudinal side 1400 of caddy body 600, and second plate 1306B is disposed transversely farther away from axis X than is a second, opposed longitudinal side 1402 of the caddy body 600.

FIG. 14B illustrates a “both brackets in” configuration. Brackets 1100 and 1102 have been reversed, such that plate end 1302A is closer to axis X than plate end 1304A, and such that plate end 1302B is closer to axis X than plate end 1304B.

As well seen in this view, the body 600 of caddy 108 has been modified from the embodiment shown in FIGS. 6A and 6B, such that a lower edge 1404 of side 1400 has a notch or channel 1406 made in it to accommodate plate 1300A. A depth 1408 of the channel 1406 in the longitudinal direction is a little larger than the depth 1316 of plate 1300A. A vertical height of the channel 1406 is a little larger than the height 1314 of plate 1300A. Similarly, a lower edge 1410 of the side 1402 has a notch or channel 1412 made in it to accommodate plate 1300B. A depth 1414 of the channel 1412 in the longitudinal direction is a little larger than the depth 1316 of plate 1300B. A vertical height of the channel 1412 is a little larger than the height 1314 of plate 1300B. In the illustrated embodiment, the depths and heights of the channels 1406, 1412 are the same, but they would be different if the cross-sectional shapes of plates 1300A, 1300B were not the same. The channels 1400, 1402 have been provided so that the transverse sliding of plates 1300A, 1300B beyond respective sides 1402, 1404 will not be inhibited.

In the configuration shown in FIG. 14B, gripping elements 1338A and 1338B face toward axis X and will be used to grip the sidewalls of a relatively thin upstanding furniture feature. The plates 1306A and 1306B could be slid even closer together than the configuration shown here, such that slot end 1328A substantially aligns with first bolt boss hole 701A (with just enough space for bolt head 1204), and such that slot end 1328B substantially aligns with second bolt boss hole 701B, again with just enough space for bolt head 1204.

In the configuration shown in FIG. 14C, the bracket 1100 has been affixed to body 600 in an “out” position but the bracket 1102 has been affixed to body 600 in an “in” position. In this configuration, plate 1306A is farther away from axis X than is side 1400 and is farther away from axis X than is plate 1306B. As so affixed, gripping elements 1334A will grip one sidewall of an upstanding furniture feature (see FIG. 15) while gripping elements 1338B will grip an opposed sidewall of the furniture feature. The furniture feature, such as a chair arm, will have at least an approximate longitudinal axis F. This configuration displaces body axis X to one side of axis F. The result is that the caddy body 600 will not sit directly on top of the furniture feature, but somewhat to one side of it. For example, a configuration like that shown in FIG. 14C, as attached to a chair arm, could more easily permit the ingress or egress of an occupant of the chair (where the seat of the chair is to the left of axis F in FIG. 14C). Alternatively, the brackets 1100, 1102 could be reversed, or the orientation of caddy 108 reversed, so as to place the contents of caddy 108 more directly in front of the seat occupant.

FIG. 15 schematically illustrates an upstanding furniture feature 1500, such as the upholstered arm of an easy chair. Feature 1500 may be composed in part or entirely by a foamed elastomer with shape memory. Feature 1500 has an upper surface 1502, a downwardly depending left sidewall 1504 and an opposed, downwardly depending right sidewall 1506. Plates 1300A and 1300B are transversely displaced by sliding their respective slots 1324A and 1324B with respect to the caddy bolts 1204A and 1204B, until plates 1306A and 1306B respectively press on walls 1504 and 1506, clamping the caddy body 600 to the feature 1500. The illustrated feature 1500 is a significantly upholstered chair arm where the feature surface 1508 will deflect when pressure is placed on it. Once this happens, surface 1508 will attempt to return to its original shape. This tendency to return to the feature's original shape more firmly attaches the caddy 108 to the feature 1500.

In summary, a foamed elastomer tailgate seat has been provided that makes sitting on a tailgate more comfortable, with an affixation system that makes the seat's installation and removal easy. A beverage container caddy may be affixed to the tailgate seat but may also be used separately and be attached to other horizontal upholstered surfaces and/or upstanding furniture features.

While illustrated embodiments of the present invention have been described and illustrated in the appended drawings, the present invention is not limited thereto but only by the scope and spirit of the appended claims.

We claim:

1. A tailgate seat comprising:
a seat body having an upper surface, a lower surface downwardly spaced from the upper surface and a plurality of through-holes extending from the upper surface to the lower surface, the through holes being spaced apart from each other; and
a plurality of fastening systems for fastening the seat body to a tailgate of a vehicle, each fastening system provided for a respective one of the through-holes and including
a grommet with a top flange, a bottom flange downwardly spaced from the top flange and a sidewall formed around a grommet axis, the sidewall downwardly extending from the top flange to and past the bottom flange to a lower end, the sidewall having an internal surface and an external surface, the bottom flange and the top flange radially outwardly extending from the external surface of the sidewall;
a first detenting surface formed in the internal surface of the sidewall to be upwardly spaced from the lower end of the sidewall;
the fastening system further including an affixation member for affixation to an upper surface of the tailgate, the affixation member disposed on the axis and having a base and a sidewall upwardly extending from the base, the sidewall of the affixation member having an external surface, a second detenting surface formed on the external surface of the sidewall of the affixation member and adapted to engage the first detenting surface; wherein
the top flange of the grommet is disposed on the upper surface of the seat body, the bottom flange of the grommet is disposed on the lower surface of the seat body, and, in use, the first detenting surface snaps to the second detenting surface to affix the tailgate seat to the tailgate.

2. The tailgate seat of claim 1, wherein the first detenting surface is radially inwardly concave and the second detenting surface is radially outwardly convex.

3. The tailgate seat of claim 1, wherein the sidewall of the grommet is endless in a plane orthogonal to the axis.

4. The tailgate seat of claim 3, wherein the first detenting surface is endless in a plane orthogonal to the axis.

5. The tailgate seat of claim 4, wherein the first detenting surface is a circular channel.

6. The tailgate seat of claim 1, wherein the sidewall of the affixation member is endless in a plane orthogonal to the axis.

7. The tailgate seat of claim 6, wherein the second detenting surface is endless in a plane orthogonal to the axis.

8. The tailgate seat of claim 7, wherein the second detenting surface is a radially outwardly convex, circular enlargement.

9. The tailgate seat of claim 1, wherein the base of the affixation member has a central hole disposed on the axis, the affixation member further including a bolt or screw inserted through the central hole and used to fasten the affixation member to the tailgate.

10. The tailgate seat of claim 1, wherein the top flange of the grommet radially inwardly extends across the sidewall of the grommet to create a cap.

11. The tailgate seat of claim 1, wherein the bottom flange of the grommet has an outer edge, a plurality of gussets each having lower edges which extend from the outer edge radially inwardly and downwardly, the gussets being radially spaced from each other around the axis and used to temporarily force open the respective seat body through-hole when the grommet is inserted into and through the through-hole, such that after insertion the bottom flange is disposed below and adjacent to the lower surface of the seat body.

12. The tailgate seat of claim 1, wherein the seat body comprises elastomeric foam.

13. A tailgate seat for affixation to an upper surface of a tailgate of a vehicle having a surface with a plurality of spaced-apart bolt holes at predetermined locations, the tailgate seat comprising:
a seat body formed of elastomeric foam, the seat body having an upper surface and a lower surface, a plurality of through-holes formed from the upper surface to the lower surface, the through-holes being spaced from each other, a location of each through-hole matching a respective predetermined location of a bolt hole;
for each of the bolt holes, an affixation member affixed to the bolt hole and having an upstanding sidewall with an exterior surface; and
for each of the through-holes, a grommet inserted therethrough, each grommet having a sidewall with an interior surface, a first detenting surface formed on the interior surface of the sidewall of the grommet, a second detenting surface formed on the exterior surface of the affixation member, the first detenting surface snapping to the second detenting surface to releasably affix the tailgate seat to the tailgate.

14. The tailgate seat of claim 13, wherein the tailgate seat has a rear edge, a raised lip formed on the upper surface of the seat body to be adjacent the rear edge.

15. The tailgate seat of claim 13, further comprising a beverage caddy, a lower surface of the beverage caddy resting on the upper surface of the seat body, the beverage caddy having a base and at least one beverage container receptacle upwardly extending from the base, the base having a plurality of bolt bosses each defining a bolt boss hole, for each bolt boss, a caddy bolt and a washer, a shaft of the caddy bolt inserted through the washer, through the seat body from the lower surface of the seat body to the upper surface of the seat body and through the bolt boss hole, a respective knob threaded onto the shaft of the caddy bolt to thereby clamp the cup caddy to the seat body.

16. The tailgate seat of claim 15, wherein the base of the beverage caddy has an outer periphery, the beverage caddy affixed to the upper surface of the seat body at a predetermined location such that the outer periphery of the base of the beverage caddy is horizontally spaced from all of the grommets.

17. The tailgate seat of claim 13, wherein, for each through-hole a countersink on the upper surface of the seat body surrounds the through-hole, and a countersink on the lower surface of the seat body surrounds the through-hole, the countersink on the upper surface of the body receiving the top flange of a respective grommet, the countersink on the lower surface of the body receiving the bottom flange of the respective grommet.

18. A method of affixing a tailgate seat to a tailgate of a predetermined make and model of vehicle, comprising the steps of:
removing, from each of a plurality of spaced-apart bolt hole locations in an upper surface of the tailgate, an original bolt;
affixing, at each bolt hole, a respective affixation member;
providing a seat body with a plurality of through-holes matching in number and location the bolt holes;
inserting, through each through-hole, a respective grommet, such that a top flange of the grommet is adjacent to the upper surface of the seat body and such that a bottom flange of ht grommet is adjacent to the lower surface of the seat body;
for each grommet, snapping a first detenting surface located on an interior surface of a sidewall of the grommet to a second detenting surface located on a exterior surface of an upstanding sidewall of the affixation member, to thereby releasably affix the tailgate seat to the tailgate.

19. The method of claim 18, wherein said step of affixing the affixation member to the respective bolt hole comprises screwing a bolt or screw through a hole in the affixation member and into the bolt hole.

20. A kit for a beverage caddy for affixation to an upholstered base, the kit comprising:
a beverage caddy body having a base with an upper surface and an opposed lower surface, at least one beverage container receptacle upwardly extending from the upper surface of the base, the body including first and second bolt bosses, the first bolt boss defining a first bolt boss hole, the second bolt boss defining a second bolt boss hole, each bolt boss hole extending from the upper surface of the base to the lower surface of the base;
a first caddy bolt having a head and a shaft, a second caddy bolt having a head and a shaft;
a first washer provided for the first caddy bolt and a second washer provided for the second caddy bolt, wherein in a first configuration the first and second washers are disposed below a lower surface of an upholstered pad and the lower surface of the caddy body is placed on an opposed upper surface of the upholstered pad, the first and second caddy bolts respectively being inserted through respective ones of the first and second washers, the upholstered pad and respective ones of the first and second bolt bosses, a first knob being tightened by the user on the shaft of the first caddy bolt and a second knob being tightened by the user on the shaft of the second caddy to clamp the beverage caddy body to the upholstered pad; and
a first bracket and a second bracket, each of the first and second brackets having a first plate with an upper surface, a lower surface and a transversely oriented slot extending from the lower surface of the first plate to an upper surface of the first plate, the first plate having a first transverse end and a second transverse end opposed to the first transverse end, and wherein for each of the first and second brackets, a second plate of the bracket downwardly extends from the first transverse end of the first plate;
a third caddy bolt having a head and a shaft, a fourth caddy bolt having a head and a shaft;
wherein in a second configuration, the shaft of the third caddy bolt is upwardly inserted through the slot of the first plate of the first bracket and through the first bolt boss hole, the shaft of the fourth caddy bolt being upwardly inserted thorough the slot of the first plate of the second bracket and through the second bolt boss hole, the first knob being threaded onto the shaft of the third caddy bolt, the second knob being threaded onto the shaft of the fourth caddy bolt, the lower surface of the caddy body being placed on an upper surface of an upstanding furniture feature having opposed first and second sidewalls downwardly extending from the upper surface of the furniture feature, a transverse position of each second plate being adjusted to press against a preselected one of the first and second sidewalls by sliding the slot of the first plate with respect to the head of a respective one of the third and fourth caddy bolts, the knob of the respective one of the third and fourth caddy bolts then tightened, whereby the second plates of the brackets clamp the caddy body to the furniture feature.

21. The kit of claim 20, wherein the caddy body has a left side and an opposed right side spaced from each other in a transverse direction, the first plate of each of the first and second brackets having a uniform depth in a longitudinal direction at right angles to the transverse direction and a thickness in a vertical direction at right angles to the transverse and longitudinal directions, a lower edge of the left side having a first channel and a lower edge of the right side having a second channel, a length of the first channel in the longitudinal direction being more than the depth of the first plate of the first bracket, a height of the first channel in the vertical direction being more than the thickness of the first plate of the first bracket, a length of the second channel in the longitudinal direction being more than the depth of the first plate of the second bracket, a height of the second channel in the vertical direction being greater than the thickness of the first plate of the second bracket, so that the first plate of the first bracket may freely slide transversely outwardly through the first channel, and so that the first plate of the second bracket may freely slide transversely outwardly through the second channel.

22. The kit of claim 20, wherein
the caddy body has a longitudinal axis, and in the second configuration, and for each of the first and second brackets, the bracket may be affixed to the caddy body such that the first transverse end of the first plate is closer to the longitudinal axis than is the second transverse end of the first plate, and that alternatively the bracket may be affixed to the caddy body such that the second transverse end of the first plate is closer to the longitudinal axis than is the first transverse end of the first plate.

23. The kit of claim 22, wherein, for each of the first and second brackets, the second plate has opposed inner and outer surfaces, gripping elements being formed on both the inner and outer surfaces of the second plate.

24. A beverage container caddy for affixation to an upstanding furniture feature, the caddy comprising:
a caddy body having a base with an upper surface and an opposed lower surface, at least one beverage container receptacle upwardly extending from the upper surface of the base, the body including first and second bolt bosses, the first bolt boss defining a first bolt boss hole, the second bolt boss defining a second bolt boss hole, each bolt boss hole extending from the upper surface of the base to the lower surface of the base;
a first caddy bolt having a head and a shaft, a second caddy bolt having a head and a shaft;
a first bracket and a second bracket, each of the first and second brackets having a first plate with an upper surface, a lower surface and a transversely oriented slot extending from the lower surface of the first plate to an upper surface of the first plate, the first plate having a first transverse end and a second transverse end opposed to the first transverse end, and wherein for each of the first and second brackets, a second plate of the bracket downwardly extends from the first transverse end of the first plate;
the shaft of the first caddy bolt being upwardly inserted through the slot of the first plate of the first bracket and through the first bolt boss hole, the shaft of the second caddy bolt being upwardly inserted thorough the slot of the first plate of the second bracket and through the second bolt boss hole, a first knob being threaded onto the shaft of the first caddy bolt, a second knob being threaded onto the shaft of the second caddy bolt, the lower surface of the caddy body being placed on an upper surface of the upstanding furniture feature, opposed first and second sidewalls of the upstanding furniture feature downwardly extending from the upper surface of the furniture feature, a transverse position of each second plate being adjusted to press against a respective one of the first and second sidewalls by sliding the slot of the respective first plate with respect to the head of the respective caddy bolt, the knob of the respective caddy bolt then tightened, whereby the second plates of the first and second brackets clamp the caddy body to the furniture feature.

25. The beverage caddy of claim 24, wherein the upstanding furniture feature is an upholstered chair arm.

26. The beverage caddy of claim 24, wherein the caddy body has a left side and an opposed right side spaced from each other in a transverse direction, the first plate of each of the first and second brackets having a uniform depth in a longitudinal direction at right angles to the transverse direction and a thickness in a vertical direction at right angles to the transverse and longitudinal directions, a lower edge of the left side having a first channel and a lower edge of the right side having a second channel, a length of the first channel in the longitudinal direction being more than the depth of the first plate of the first bracket, a height of the first channel in the vertical direction being more than the thickness of the first plate of the first bracket, a length of the second channel in the longitudinal direction being more than the depth of the first plate of the second bracket, a height of the second channel in the vertical direction being greater than the thickness of the first plate of the second bracket, so that the first plate of the first bracket may freely slide transversely outwardly through the first channel, and so that the first plate of the second bracket may freely slide transversely outwardly through the second channel.

27. The beverage caddy of claim 24, wherein
the caddy body has a longitudinal axis, and for each of the first and second brackets, the bracket may be affixed to the caddy body such that the first transverse end of the first plate is closer to the axis than is the second transverse end of the first plate, and that alternatively the bracket may be affixed to the caddy body such that the second transverse end of the first plate is closer to the axis than is the first transverse end of the first plate.

28. The beverage caddy of claim 24, wherein, for each of the first and second brackets, the second plate has opposed inner and outer surfaces, gripping elements being formed on both the inner and outer surfaces of the second plate.

29. The beverage caddy of claim 24, wherein the caddy body has a front side, a rear side of the caddy body being longitudinally spaced from the front side, the at least one beverage holder being longitudinally displaced from the first and second bolt bosses.
